(19) United States
(12) Patent Application Publication
(10) Pub. No.: US 2008/0275762 A1
(43) Pub. Date: Nov. 6, 2008

(54) VIDEO EMAIL WITH INFORMATION TRACKING

(75) Inventors: Wade Cutler, Grand Rapids, MI (US); Brad Warmuskerken, Grand Rapids, MI (US); Henry R. Dunnick, Grand Rapids, MI (US)

Correspondence Address: Flynn, Thiel, Boutell & Tanis, P.C, 305B WATERS BUILDING, 161 Ottawa Ave., N.W., Grand Rapids, MI, 49503, US

(73) Assignee: Resource Communications, Inc., Grand Rapids, MI (US)

(21) Appl. No.: 12/115,249

(22) Filed: May 5, 2008

Related U.S. Application Data
(60) Provisional application No. 60/915,834, filed on May 3, 2007.

(51) Int. Cl. G06Q 30/00; G06F 15/16

(52) U.S. Cl. 705/10; 709/206

(57) ABSTRACT

A system and method for identifying and tracking recipient behavior in connection with a multimedia presentation incorporated in an email. The email is received in the manner of an ordinary text email, but when the email is opened, it automatically commences the display of a multi-media presentation that includes streaming video that provides information about the viewing experience to the sender. When the recipient elects to open the email message, the recipient's computer is identified to the sender and correlated with information relating to the recipient's interaction with the program. Such information can include the portions of the program viewed by the recipient and the length of time each portion is viewed, and the identity of any recipient to whom the information is forwarded.

### CROSS REFERENCE TO RELATED APPLICATIONS

The present application is based on and claims the filing priority of Applicants' co-pending U.S. Provisional Patent Application No. 60/915,834, filed May 3, 2007, and entitled VIDEO EMAIL WITH INFORMATION TRACKING, the disclosure of which is incorporated herein by reference.

### BACKGROUND OF THE INVENTION

It is common practice for companies to send emails to prospective customers or customers whose email addresses have been obtained from various sources. A recipient of an email has the option of viewing or deleting it. Generally, the only information available to the sender is the number of recipients that have clicked on the email to view it, recipient's name and if they clicked on various other links but not the period of time they viewed the video or if the video email opened automatically and began to play.

An object of the present invention is to provide a video or multi-media email communication system with recipient information tracking that is actuated when the recipient chooses to view the email, with the sender thereafter being provided with the identity of the recipient, the particular aspects or sections of the email that the recipient viewed, the amount of time that the recipient viewed each feature of the email, who the recipient forwarded the email to using the program's mail forwarding feature, and other viewing information. All of this information provides an important commercial advantage for marketing or communication use and provides valuable information for training or educational purposes.

### DESCRIPTION OF THE INVENTION

The present invention comprises an internet-based communications tool that brings a new dimension to internet communications and provides important and valuable information to the sender relating to the recipient's use and reaction to the email message.

In summary, the present invention comprises a system and method for identifying and tracking recipient behavior in connection with a multimedia presentation incorporated in an email. The email of the present invention is received by recipients just like an ordinary text email, but when the email is opened, it automatically commences the display of a multi-media presentation that includes streaming video and thereafter transmits information about the viewing experience back to the sender.

Since the presentation is in the form of a streaming video or like technology, wherein only a small portion of the presentation is downloaded on the recipient's computer at any one time, the streaming video can commence display almost immediately and does not require a substantial download time on the recipient's computer. Nor does the streaming video remain in the memory of the recipient's computer and is available on the computer only for the period of time during which the video is viewed. Streaming video is well known technology. In the present invention the multimedia authoring program is preferably Adobe Flash. Flash readers are attached or attachable to most internet browser programs.

An important feature of the present invention is the incorporation in connection with the use of this technology of a means for providing improved information to the sender relating to the recipient's review and reaction to the video.

In employing the present program, the sender prepares a Flash communication message or application file for transmittal to a plurality of recipients by email over the internet. The communication message can include text and graphics combined with audio and video components combined in a multi-media presentation. The multi-media presentation can also include a Power Point presentation. The presentation materials are designed to be displayed in a timed sequence, such as the timed sequence of audio and video productions. The materials are provided in a form, such as streaming video, wherein the entire presentation is not first downloaded to a computer's memory before the presentation can be viewed. Instead, the presentation is downloaded in segments as it is presented and thereafter deleted from the recipient's computer. The multi-media application file containing the audio or video presentation is herein referred to as the “program”.

The program is incorporated or embedded in an email message that appears in a recipient's inbox as a normal email. However, when the recipient clicks on the email and elects to view it, the multi-media program message is automatically displayed on the recipient's computer. The recipient can view the program for as long as he likes or he can discontinue watching the program by initiating a terminate or cancel instruction. The program can provide various sections or components that are available for separate viewing, and the recipient has the ability to select which sections he wishes to view. The recipient also can select a button that lets him forward the message to a friend.

The multi-media program includes important features. First, when the recipient elects to open the email message, the recipient's computer is specifically identified to the sender. This information is retained in the sender's computer and then correlated with information relating to the recipient's interaction with the program. Second, the program keeps track of the information displayed by the recipient and the length of time of each transmission. This can be done by having the transmitting program keep a record of the information requested by and sent to the recipient and the length of time of each transmission or by having the program on the recipient's computer transmit periodic marker signals back to the sender's computer, providing a series of discrete signals that indicate the length of time that the program or each part of the program remains open on the recipient's computer. The signals also can include identification information representing the identity of the particular portion of the program that is being viewed at each particular time and any reaction by the recipient to the program and virtually any other information about the viewing experience that the sender wishes to collect. Thus, when a recipient elects to view the email message, the sender is provided with the identity of the recipient, the portions of the email viewed, and the time that each portion is viewed, information about messages that are forwarded to others (when the program's “forward” instruction is elected by the recipient), and other information that is desired.

Detailed information about the viewing experience of individual, identified recipients provides important information to senders relating to potential customers and matters in which the potential customers may be interested. For example, it is well known that the length of time a recipient watches a video presentation on a particular subject provides a good indication of the recipient's interest in the subject matter and the likelihood that a subsequent solicitation will be successful or at least worthwhile. This information can be used for subsequent contacts with the individual recipient by the same sender or it can be used to produce a more precisely formulated mailing list for subsequent usage by others. This information is far more valuable than a mere indication that a particular email message provided a certain number of hits from unspecified recipients.

In addition to providing information about the preferences of the recipient receiving the program, the program can provide a means by which the recipient can forward the program to other persons who may be interested in viewing the program and additionally track if a recipient clicked on other links that may indicate a recipient interest, giving even greater information to the sender about that recipient. When the program is forwarded by a primary recipient to secondary recipients selected by him clicking the forward button on the main page of the program, information relating to the secondary recipients becomes available to the sender in the same manner as the information relating to the primary recipient.

The program desirably is employed as a web based program administered by an email advertising service provider. The email communication may have a number of separate elements that may be individually selected. The elements sent to any one recipient can be determined by the service provider or by the customer that is sponsoring the message or by his advertising representative. The customer may desire to be directly involved in small emailings but have the service provider handle larger mailings.

The internet communications of the present invention are set up to be sent as individual emails to each mail recipient, such that the emails are addressed to the individual mail recipients and not to generic “recipient”. This personalizes the messages and makes them more likely to be opened, and it also minimizes blocking by spam filters that are sensitive to generic email addresses.

While the present program is intended to function in the presence of filter software on a recipient's computer, in the event that filter software affects the automatic operation of the program on any computer, the program includes a screen instruction wherein a recipient is provided a means (such as a button that can be clicked to “view program”) whereby the recipient can elect to view the program and override the filter. This type of device is conventional.

A list of features and benefits for the present technology is as follows:
Multimedia—Recipients can view audio and video clips, which can be supported with a PowerPoint presentation, uninterrupted.
Portability—Access in multiple locations and can reside as part of a web site, on a desktop, in an email and all at the same time.
Real Time Communications—All direct audio, video recording and email broadcasting along with PowerPoint presentation materials are built-in.
Ease of Authoring—Web based tools allow the sender to upload content without any software or programming knowledge and does not involve the sender's Information Technology Department.
Real Time Updates—Tracking reports are updated in real time.
Depth of Content—There is no limit to the amount of content that can be pre-recorded
Personalized—For one-to-one and one-to-many messaging through text, graphics, video and audio. Allows for sending of highly targeted messages.
Trackability—Allows for segmented tracking of all users.
Viral Marketing—This process includes a FORWARDING component allowing recipients to pass it along to colleagues and customers—increasing the distribution and growth of a campaign. All tracked by the provider's web system that gives open rates, viewing time and information that has never been available to track the success of messages.
   A list of uses of the present technology is as follows:
Deliver timely information and value-added offers in one communication with multiple offers (rather than multiple communications with single offers).
Deliver consistent sales/recruitment, training, and instructional messages, including video presentations.
Build relationships and marketing partnerships.
Motivate target audience to act.
Reduce sales/recruitment costs, both internally and externally. Accommodate real time tracking updates
Drive attendance at special events.
Track staff and current and prospective customers/members interest in specific offerings, services, and information.

The foregoing is illustrative of the preferred practice of the present invention. Various changes in the arrangement of the details of the present invention may be made without departing from the spirit and scope of the present invention.

1. A video email that provides information tracking to the email sender about the recipient's response to the receipt of the email, comprising:
a video email containing at least one time sequenced video message that is displayed automatically to an email recipient after receipt and selection thereof;
a plurality of time spaced marker signals incorporated into each email, the marker signals being tracked by the sender's computer so as to determine the length of time that the video email is being displayed on the recipient's computer; and
means for providing the identity of the email recipient to the sender and correlating the recipient's identity with the information relating to the time of viewing, such that the sender can determine both the recipient who watched the email video message and for how long.

2. A video email as in claim 1 wherein the video email contains a plurality of separate parts or sections that can be individually displayed at the option of the recipient, the marker signals incorporating information sufficient for the sender to identify which of the plurality of messages in the sender's email were viewed by the recipient as well as the length of time each message was viewed.

3. A video email as in claim 1 wherein the video email includes a mail forwarding selection means, the selection means including detection means for detecting when and to whom the email is forwarded by the recipient, using the mail forwarding selection means.

4. A video email as in claim 1 wherein the video email includes multiple links to one or more other websites, videos, contacts and literature information, and the video email includes means for detection when such links are accessed, the email including means for tracking the identity and length of time of access to each video link.

5. A video email as in claim 1 wherein the video email when sent shows only the individual's name or email address and not a generic name as the email addressee, all email addresses in a group of addresses being individual email addresses, increasing the opportunity for the messages to be received by a recipient.

6. A video email as in claim 1 wherein the email is a web based program administered by an email advertising service provider, the content of the email comprising one or more separate elements that may be individually selected for any recipient, the elements sent to any one recipient being selected by one of the service provider, the customer commissioning the advertising, or an advertising representative thereof.
